(19) United States
(12) Patent Application Publication
(10) Pub. No.: US 2007/0023518 A1
(43) Pub. Date: Feb. 1, 2007

(54) Reader-writer array and reader-writer array unit

(75) Inventors: Nobuyuki Tada, Odawara (JP); Nobuaki Higashi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/494,731

(22) Filed: Jul. 28, 2006

(30) Foreign Application Priority Data
Jul. 29, 2005 (JP) 2005-219838

(51) Int. Cl. G06K 7/00; G06K 7/08

(52) U.S. Cl. 235/435; 235/486; 235/451

(57) ABSTRACT

A reader-writer array which collectively reads or writes management information of each of a plurality of managed articles that are stored in a rack. The reader-writer array includes a plurality of readers-writers for wirelessly reading or writing management information which is stored in a RFID tag mounted on each of the managed articles. The reader-writer array further includes a support member having the plurality of readers-writers attached thereto. The support member is formed separately from the rack. The readers-writers are attached to the support member so that they correspond to positions of a plurality of managed articles arranged and stored on at least one shelf of the rack.

### CROSS REFERENCE TO RELATED APPLICATIONS

This application claims the foreign priority benefit under Title 35, United States Code, §119(a)-(d) of Japanese Patent Applications No. 2005-219838, filed on Jul. 29, 2005, the contents of which are hereby incorporated by reference.

### BACKGROUND OF THE INVENTION

1. Field of the Invention

The present invention relates to a reader-writer array and a reader-writer array unit, and more particularly to a reader-writer array and a reader-writer array unit that are capable of collectively reading or writing management information of a plurality of managed articles that are stored on shelves of a rack.

2. Description of the Related Art

Magnetic tape cartridges are known as external storage media for computers, etc., and are used to backup data. Typically, within a fireproof and heatproof storehouse, a plurality of magnetic tape cartridges storing data are arranged and stored in a rack S as shown in FIG. 8. When the magnetic tape cartridges MCs are taken out from the rack S, they are loaded in a carrying wagon C as shown in FIG. 9 and transported.

As a method of managing the magnetic tape cartridges MCs stored on the shelves of the rack S, a method which uses, for example, a RFID tag mounted on each magnetic tape cartridge has been proposed. This is disclosed in, for example, claim 1, paragraphs [0009] to [0010], and FIG. 1 of the Japanese Laid-Open Patent Publication No. 2000-285635.

The aforementioned Patent Publication No. 2000-285635 discloses a cartridge storing device, which comprises a shelve body for housing a plurality of magnetic tape cartridges with a memory seal attached thereto and a lid attached to the side portion of the shelve body so that it is turnable. In the cartridge storing device, a plurality of interfaces for transmitting and receiving data information without contacting each magnetic tape cartridge are provided in the lid so that they correspond to the memory seals of the magnetic tape cartridges housed in the shelve body. According to this cartridge storing device, the data information of the memory seal of each of all magnetic tape cartridges housed in the shelve body can be read at a time, as a result, a real time inventory control becomes possible.

However, if the interfaces are fixedly provided for each storing device so that they correspond to all magnetic tape cartridges, there has been a problem that the cost of the whole device becomes higher.

In addition, an increase in the number of the interfaces also causes increase of a device maintenance cost.

These problems are not only limited to the magnetic tape cartridge, but also take place for all managed articles that are stored on the shelves of a rack.

### SUMMARY OF THE INVENTION

The present invention has been made in view of the problems described above. Accordingly, it is an object of the present invention to provide a reader-writer array and a reader-writer array unit which are capable of reading and writing management information, by a predetermined unit, of each of a plurality of managed articles that are stored in a rack. Another object of the present invention is to provide a reader-writer array and a reader-writer array unit that have general-purpose properties and are low in price.

To achieve the foregoing objects, there is provided a reader-writer array for collectively reading and writing management information of each of a plurality of managed articles that are stored in a rack. The reader-writer array comprises two major components: (1) a plurality of readers-writers for wirelessly reading and writing management information which is stored in a RFID tag mounted on each of the managed articles; and (2) a support member having the plurality of readers-writers attached thereto, and formed separately from the rack. The readers-writers are attached to the support member so that they correspond to positions of a plurality of managed articles arranged and stored on at least one shelf of the rack.

According to the above reader-writer array, if the support member is attached to face a predetermined shelf of the rack, the readers-writers attached to the support member correspond to the positions of the managed articles arranged and stored on that shelf. This makes it possible for each reader-writer to read and write the management information which is stored in the RFID tag of each managed article, without contacting the tag. Thus, since the management information of each of the managed articles is read or written by a predetermined unit, the working efficiency is improved. In addition, in this reader-writer array, the reader-writer array is formed separately from the rack, so it can be attached to an intended rack. This makes it possible to apply a single reader-writer array to a plurality of racks.

Note that the readers-writers may be attached to the support member so that they correspond to a plurality of shelves.

In the reader-writer array of the present invention, the aforementioned support member has a shelf identification reader-writer for reading shelf identification information provided on each shelf of the rack.

According to the above reader-writer array, the shelf identification reader-writer reads the shelf identification information of each shelf of the rack. This makes identification of each shelf easier. Note that if the shelf identification information and the reader-writer array position (number) are checked when each tape cartridge is identified, an information map of a tape storing location within a storehouse can be produced.

In the reader-writer array of the present invention, both side portions of the aforementioned support member are provided with positioning members that abut both side portions of the rack so that a positional relation of the reader-writer array with the rack is adjusted.

According to the above reader-writer array, the positioning members abut both side portions of the rack so that the positional relation of the reader-writer array with the rack is adjusted. Because a distance between the readers-writers and the RFID tags becomes stable, the reading stability can be improved.

The foregoing objects are also accomplished in accordance with the present invention by providing a reader-writer array unit which comprises two major components: (1) the aforementioned reader-writer array and (2) a movable wagon provided with the reader-writer array.

According to the above reader-writer array unit, since the reader-writer array is provided on the movable wagon, traveling to another rack becomes easy, thereby resulting in improvement of the working efficiency.

In the reader-writer array unit of the present invention, the aforementioned reader-writer array comprises reader-writer arrays provided in a plurality of rows on the wagon so that the reader-writer arrays correspond to a plurality of shelves of the rack.

According to the above reader-writer array unit, if the wagon is moved to face the rack, the reader-writer arrays correspond to the shelves of the rack, respectively. Then, the readers-writers of each reader-writer array correspond to the positions of a plurality of managed articles stored on each shelf. This makes it possible for each reader-writer to read and write management information which is stored in the RFID tag of each managed article, without contacting the tag. Thus, the management information of each of all managed articles stored in the rack can be read or written at a time.

In the reader-writer array unit of the present invention, the aforementioned reader-writer array is movable in an up-and-down direction with respect to the wagon so that it can correspond to each of a plurality of shelves of the rack.

According to the above reader-writer array unit, if the reader-writer array is moved in the up-and-down direction, it can be positioned to correspond to each shelf of the rack. This makes it possible to sequentially read and write the information, by a predetermined unit, of each of all managed articles that are stored in the rack.

In the reader-writer array unit of the present invention, the aforementioned reader-writer array is detachably fixed to the wagon.

According to the above reader-writer array unit, the reader-writer array can be detached from the wagon. This makes it possible to interchange the reader-writer array with another reader-writer array that differs in an interval between the readers-writers or in the number of the reader-writer, depending upon the rack used.

In the reader-writer array unit of the present invention, the aforementioned reader-writer array is attached to the wagon so that an angle of the reader-writer array can be changed according to a vertical angle of each shelf of the rack.

According to the above reader-writer array unit, the vertical angle of the reader-writer array can be changed. This makes it possible to apply the reader-writer array unit to a rack that differs in shelf's angle.

In the reader-writer array unit of the present invention, the support member of the aforementioned reader-writer array is formed integrally with the wagon.

According to the above reader-writer array unit, the reader-writer array unit can be made with a simple structure compared with the case where the support member and the wagon are formed separately.

According to the aforementioned reader-writer array and reader-writer array unit, the management information of each of a plurality of managed articles that are stored in the rack can be collectively read or written by a predetermined unit. Then, they have general-purpose properties and can improve their working efficiency. Since a single reader-writer array can correspond to each shelf of the rack, the reader-writer array unit becomes cheaper than a conventional reader-writer array unit where interfaces are provided for each shelf.

In addition, according to the aforementioned reader-writer array unit, traveling to a plurality of racks can be made easier, thereby resulting in having general-purpose properties and improving the working efficiency.

### BRIEF DESCRIPTION OF THE DRAWINGS

The present invention will be described in further detail with reference to the accompanying drawings wherein:

FIG. 1 is a perspective view showing a reader-writer array unit constructed in accordance with a first embodiment of the present invention;

FIG. 2 is a back elevational view of the reader-writer array unit according to the first embodiment;

FIG. 3 is a side elevational view of the reader-writer array unit faced to a rack, according to the first embodiment;

FIG. 4 is a perspective view showing an example of modification of the reader-writer array unit according to the first embodiment;

FIG. 5 is a side elevational view showing a reader-writer array unit faced to a rack, which is constructed in accordance with a second embodiment of the present invention;

FIG. 6 is a perspective view showing a reader-writer array unit constructed in accordance with a third embodiment of the present invention;

FIG. 7 is a side view of the reader-writer array unit placed on a carrying wagon, according to the third embodiment;

FIG. 8 is a perspective view showing a rack in which magnetic tape cartridges are stored; and

FIG. 9 is a perspective view showing a carrying wagon in which magnetic tape cartridges are loaded.

### DETAILED DESCRIPTION OF THE PREFERRED EMBODIMENTS

### First Embodiment

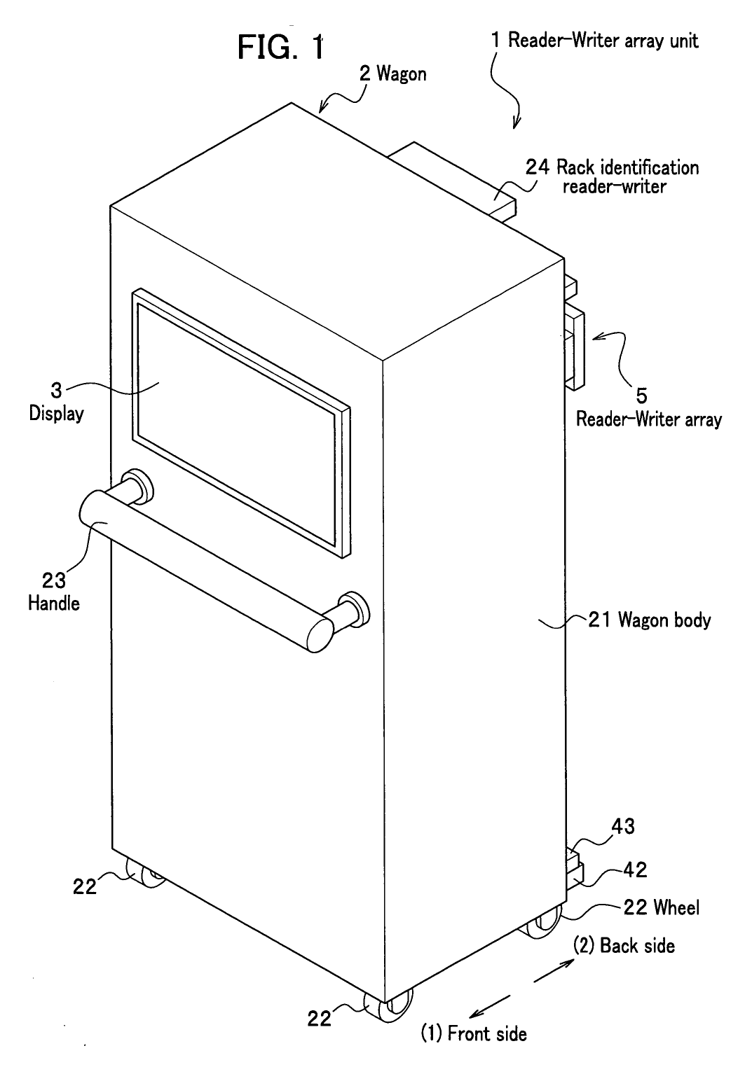

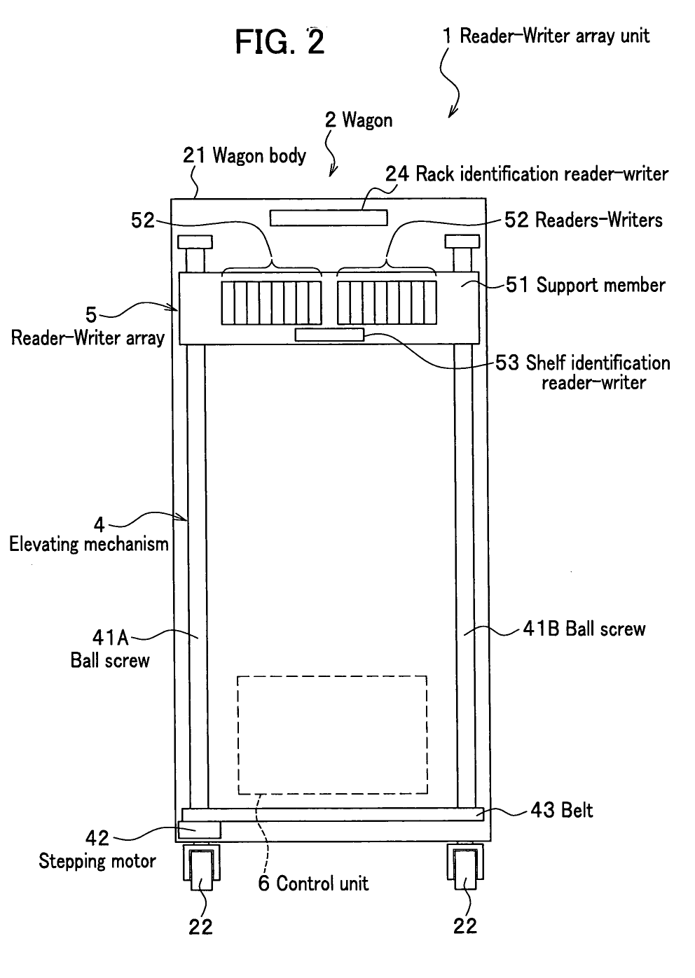

Next, an embodiment of the present invention will be explained in detail by referring to figures, as needed. FIG. 1 is a perspective view of a reader-writer array unit according to a first embodiment. FIG. 2 is a back elevational view of a reader-writer array unit according to the first embodiment.

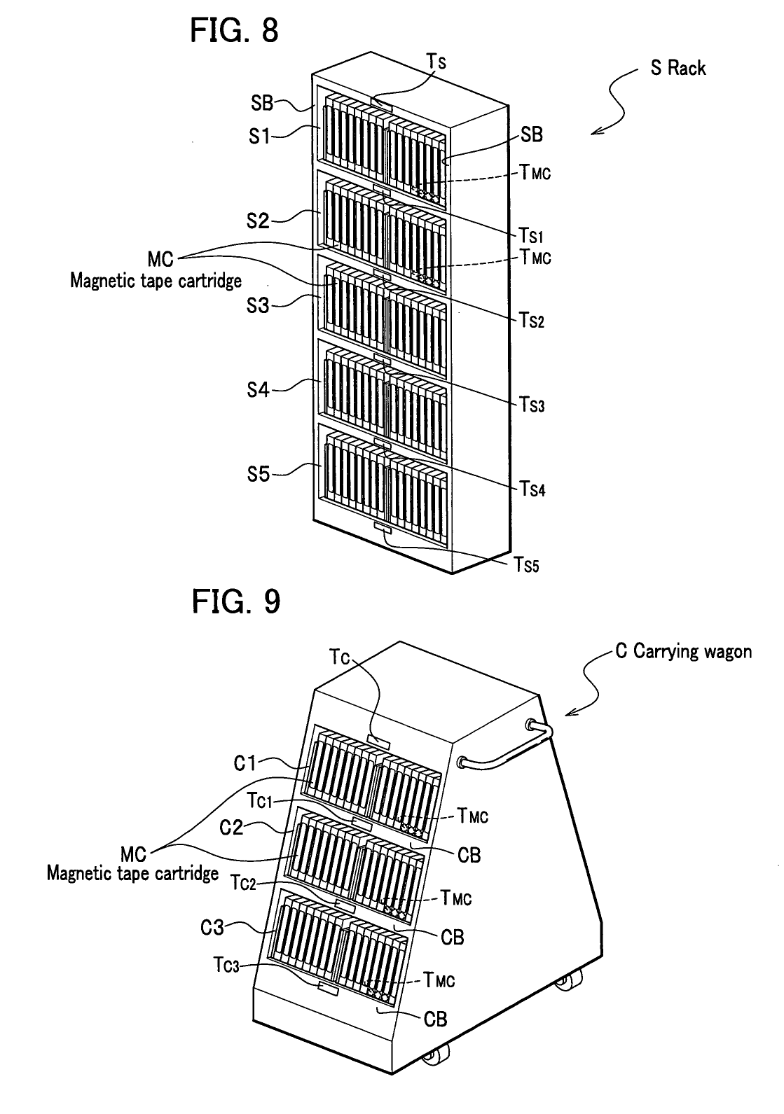

In the first embodiment, assume that managed articles are a plurality of magnetic tape cartridges MCs stored in the rack S shown in FIG. 8. Each magnetic tape cartridge MC has a tag T_{MC} (RFID tag) in which an IC chip and an antenna are integrally formed. Using management information stored in this IC chip, the magnetic tape cartridge MC is managed. Note that the aforementioned tag T_{MC} is arranged inside of the magnetic tape cartridge close to an internal surface of the front wall of the magnetic tape cartridge MC to which a label is attached. The management information that is stored in the tag T_{MC} is, for example, identification information, location information, etc., unique to each magnetic tape cartridge MC.

A rack S has five shelves S1 to S5. A tag T_{S} storing identification information of the rack S is attached to the upper central portion of the front side of the rack S while facing horizontally. Likewise, tags T_{S1} to T_{S5} storing identification information of each of the shelves S1 to S5 are attached to the bottom plates of the shelves S1 to S5 while facing horizontally. In the first embodiment, assume that the tag T_{S} and tags T_{S1} to T_{S5} are the same RFID tag as the tag T_{MC}, but they may be any type of tags as long as it represents identification information such as a barcode, etc.

As shown in FIG. 1, a reader-writer array unit 1 is equipped with a wagon 2, a display 3 attached to the front side of this wagon 2, an elevating mechanism 4 (see FIG. 2) provided on the back side of the wagon 2, a reader-writer array 5 attached to the wagon 2 through this elevating mechanism 4, and a control unit 6 (see FIG. 2) built into the wagon 2.

The wagon 2 has a wagon body 21, four wheels 22 disposed at the lower four corners of the wagon body 21 (in FIG. 1 there are shown only three), and a handle 23 fixed to the front side of the wagon body 21. The wagon body 21 is in the form of approximately a cube and has the control unit 6 (described later) built into its lower portion. The wagon body 21 is movable by the wheels 22 that are free to roll and can be easily moved in an arbitrary direction by manipulating the handle 23 by hand so that the directions of the wheels 22 are changed. The wagon body 21 also has a rack identification reader-writer 24 attached to the upper portion of the back side (see FIG. 2). More specifically, with the wagon body 21 moved so as to face the rack S shown in FIG. 8, the rack identification reader-writer 24 is disposed at a position corresponding to the position of the rack tag T_{S} of the rack S. The rack identification reader-writer 24 comprises an antenna and a control circuit, and identifies an individual rack S from a plurality of racks by reading rack identification information without contacting the rack tag T_{S}.

The display 3 is connected to the control unit 6 described later and displays information of each magnetic tape cartridge MC stored in the rack S based on an output from the control unit 6.

As shown in FIG. 2, the elevating mechanism 4 is attached to both side portions of the back side of the wagon body 21, and comprises first and second ball screws 41A and 41B extending in the vertical direction, ball nuts (not shown) mating with the first and second ball screws 41A and 41B, a stepping motor 42 coupled to the lower end of the first ball screw 41A, and a belt 43 running between the first and second ball screws 41A and 41B.

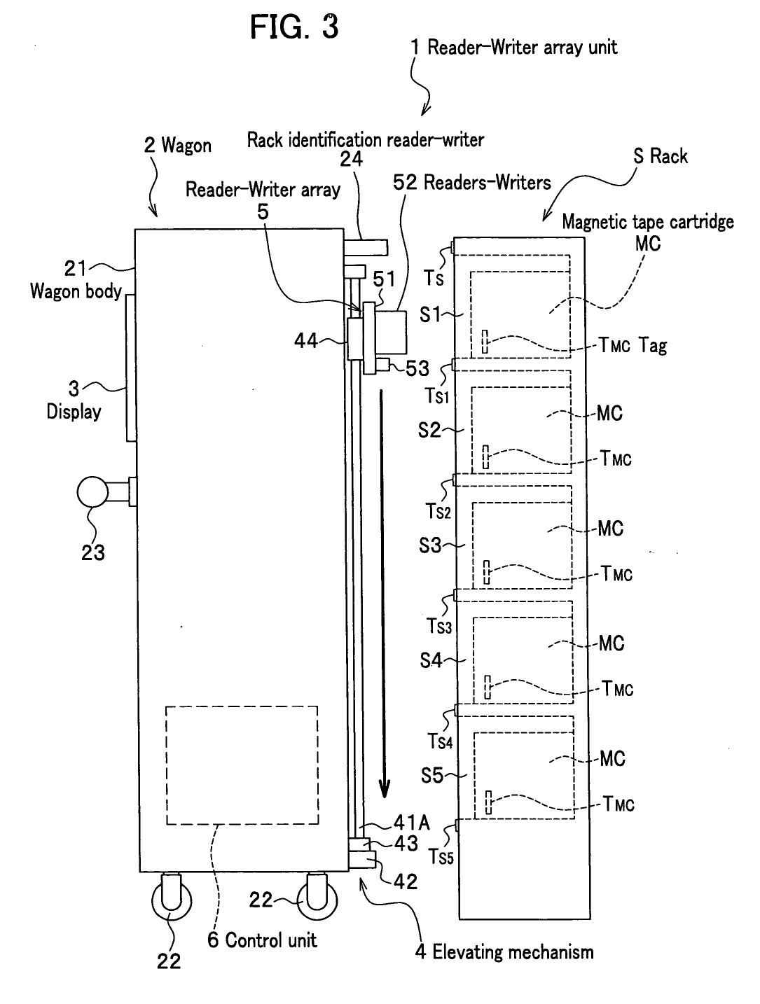

The first ball screw 41A is free to rotate by the stepping motor 41. The transmission of rotation of the first ball screw 41A through the belt 43 causes the second ball screw to rotate in synchronizing with the first ball screw 41A. The ball nuts (not shown) are fixed to the rear side of the reader-writer array 5, which will be described later, through brackets 44 (see FIG. 3). Therefore, if the first ball screw 41A is rotated by the stepping motor 42, the ball nuts (not shown) slide along the ball screws 41A and 41B in the vertical direction along with the reader-writer array 5.

The reader-writer array 5 has a support member 51, a plurality of readers-writers 52 attached to the central portion of the front side of the support member 51, and a shelf identification reader-writer 53 attached to the lower central portion of the front side of the support member 51.

The support member 51 is rectangular in shape, and wider in lateral width and about half in vertical length of an opening of each of the shelves S1 to S5 of the rack S shown in FIG. 8 (see FIG. 3). As previously described, the support member 51 is attached to the ball nuts of the elevating mechanism 4 through the brackets 44 so that it is slidable in the up-and-down direction.

The readers-writers 52 are attached to the support member 51 so that, with the support member 51 faced to the top shelf S1 (see FIGS. 3 and 8), they respectively correspond to the positions of the magnetic tape cartridges MCs arranged on the top shelf S1. Each of the readers-writers 52 comprises an antenna and a control circuit, and is able to read and write the management information of the tag T_{MC} mounted on the magnetic tape cartridge MC (see FIG. 8), without contacting the tag T_{MC}.

The shelf identification reader-writer 53 is attached to the support member 51 so that it is disposed below the readers-writers 52. Specifically, with the positions of the readers-writers 52 corresponding to the positions of the magnetic tape cartridges MCs arranged on, for example, the top shelf S1, the shelf identification reader-writer 53 corresponds to the position of the shelf tag T_{S1} of the top shelf S1. The shelf identification reader-writer 53, as with the readers-writers 52, comprises an antenna and a control circuit, and identifies the shelves S1 to S5 by reading shelf identification information of the tags T_{S1} to T_{S5} attached to the shelves S1 to S5 respectively, without contacting the tags T_{S1} to T_{S5}.

The control unit 6 is a unit containing a power source, a controller, etc., and controls driving of, for example, the rack identification reader-writer 24, the readers-writers 52, the shelf identification reader-writer 53, and the elevating mechanism 4. More specifically, the control unit 6 can read the rack identification information, the management information of the magnetic tape cartridge MC, and the shelf identification information by the rack identification reader-writer 24, the readers-writers 52, and the shelf identification reader-writer 53, and displays them on the display 3. In addition, the control unit 6 can also overwrite the management information of each magnetic tape cartridge MC stored in the tag T_{MC} by the readers-writers 52. The control unit 6 moves the reader-writer array 5 up and down by driving the stepping motor 42 of the elevating mechanism 4. Note that the control unit 6 may have a function of transferring the information read out by radio communication means such as a wireless LAN, Bluetooth (registered trademark), to another server. In this case, the server can store, compare, and update the information.

Operations of the reader-writer array unit 1 of the first embodiment will be described hereinafter with reference to FIG. 3. FIG. 3 is a side elevational view of a reader-writer array unit faced to a rack.

As shown in FIG. 3, the wagon 2 is moved close to the rack S so that the reader-writer array 5 faces the rack S. At this time, the rack identification reader-writer 24 faces the rack tag T_{S} of the rack 5 and reads the rack identification information. The reader-writer array 5 is located in advance at the position corresponding to the top shelf S1 by the elevating mechanism 4. Therefore, if the wagon 2 is moved close to the rack S, the front end portion of the reader-writer array 52 is inserted in the top shelf S1, and the reader-writer array 52 faces each tag T_{MC} of the magnetic tap cartridges MCs and reads the management information of each of the magnetic tap cartridges MCs. In addition, the shelf identification reader-writer 53 faces the tag T_{S1} and reads the shelf identification information. The information thus read is displayed on the display 3. Therefore, based on the information displayed on the display 3, the operator is able to manage each of the magnetic tape cartridges MCs. For instance, the operator is able to know the location information (the top shelf S1 of the rack S) and contents of stored data of a specified magnetic tape cartridge MC. Further, the operator is also able to judge whether or not the storage location of a magnetic tape cartridge MC is the assigned location.

If the management information of each of the magnetic tape cartridges MCs arranged and stored on the top shelf S1 is acquired, the wagon 2 is moved a little away from the rack S and then the reader-writer array 5 is lowered by the stepping motor 42 so that it corresponds to the position of the second highest shelf S2. Then, the wagon 2 is moved close to the rack S so that the front end portion thereof is inserted in the second highest shelf S2. The processing steps thereafter are carried out in the same manner as the top shelf S1. Thereafter, the same processing steps as the top shelf S1 are repeated likewise for the shelves S3, S4, and S5.

Normally, the reader-writer array unit 1 is away from the rack S, then, it is possible to recognize a label of each magnetic tape cartridge visually. Therefore, in the case of retrieving a few magnetic tape cartridges MCs, it is possible to retrieve them visually according to the label attached to them.

From the foregoing description, the first embodiment can obtain the following advantages:

(1) Since the reader-writer array unit 1 is constructed separately from the rack S, it is applicable to a plurality of other racks, and thus has general-purpose properties. Therefore, the total cost can be reduced compared with the prior art in which a plurality of interfaces for reading out a memory device are formed integrally with a rack. Further, because the number of readers-writers 52 is reduced compared with the prior art, the maintenance becomes easy and the maintenance cost can be suppressed. Furthermore, since the reader-writer array unit 1 is movable by the wagon 2, traveling to each rack S becomes easier and its operating efficiency is enhanced.

(2) In the reader-writer array unit 1, it is not necessary to prepare storing devices (racks) individually as in the prior art, and existing racks S can be utilized as they are.

(3) The reader-writer array unit 5 collectively reads the management information of each of the magnetic tape cartridges MCs arranged and stored on the five shelves S1 to S5, by each shelf. Therefore, compared with the case where magnetic tape cartridges MCs are read out one by one, the reader-writer array unit 5 can enhance its operating efficiency and can prevent human errors.

(4) Since the reader-writer array unit 5 is movable up and down, the reader-writer array unit 5 can be moved so that it correspond to each of the five shelves S1 to S5 of the rack S with a single reader-writer array unit 5. Therefore, compared with the case where five reader-writer array units corresponding to the five shelves S1 to S5 are disposed, the manufacturing cost of the single reader-writer array unit 5 can be reduced.

While the present invention has been described above with reference to the first embodiment, the invention is not limited to the embodiment, but can be implemented in various forms.

In the first embodiment, while the reader-writer array 5 is moved up and down by the elevating mechanism 5 so that it corresponds to the positions of the five shelves S1 to S5, the present invention is not limited thereto. By detachably fixing the reader-writer array 5 to the wagon body 21, the reader-writer array 5 may be reattached to the wagon body 21 by hand so that it corresponds to each of the five shelves S1 to S5. In this case, the elevating mechanism 4 can be omitted. Accordingly, the reader-writer array unit 1 can be built with a simple structure.

In the first embodiment, the readers-writers 52 are disposed in one row by attaching them on the support member 51 of the reader-writer array 5 so that the readers-writers 52 correspond to each shelves S1 to S5. However, the present invention is not limited thereto. The readers-writers 52 may be disposed in two or more rows so that they correspond to a plurality of the five shelves S1 to S5. In this case, the number of magnetic tape cartridges that can be collectively read can be increased, thereby resulting in shortening of the working time.

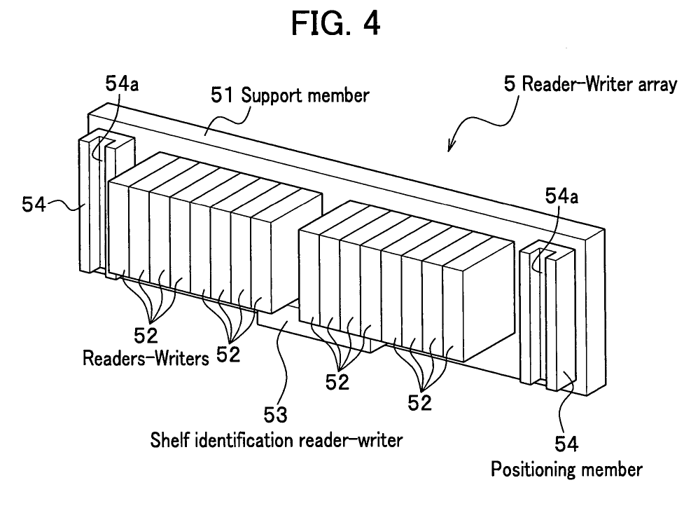

In addition, the reader-writer 5 may be modified. FIG. 4 is an example of modification of the reader-writer array 5 of the first embodiment. As shown in the figure, the support member 51 of the reader-writer array 5 may further have positioning members 54 with a U-shaped cross section, which are attached to both side portions thereof. The positioning members 54 can make stable a positional relation such as a distance between the wagon 2 and the rack S, by fitting both side plates SB and SB (FIG. 8) of the rack S into the grooves 54a thereof. Thus, the distance between the readers-writers 52 and the tag T_{MC} becomes stable, thereby resulting in improvement of the reading stability.

According to a presence or absence of communication between a reader-writer and a tag, a corresponding lamp such as a light-emitting diode (LED) may be turned on. Further, as occasion demands, by employing lamps of two or more kinds and changing lamps or lamp-blinking states between the case where the communication was recognized to be normal and the case where an abnormality (a communication failure, a wrong storage place, etc.) was detected, states and contents of the communication can also be recognized visually.

In the first embodiment, the rack identification reader-writer 24 is attached to the wagon body 21, and the shelf identification reader-writer 53 is attached to the reader-writer array 5. However, they can be omitted. In addition, the number and interval of readers-writers 52 attached to the support member 51 can also be arbitrarily changed according to the number and interval of magnetic tape cartridges MCs stored on the shelves S1 to S5 of the rack S.

### Second Embodiment

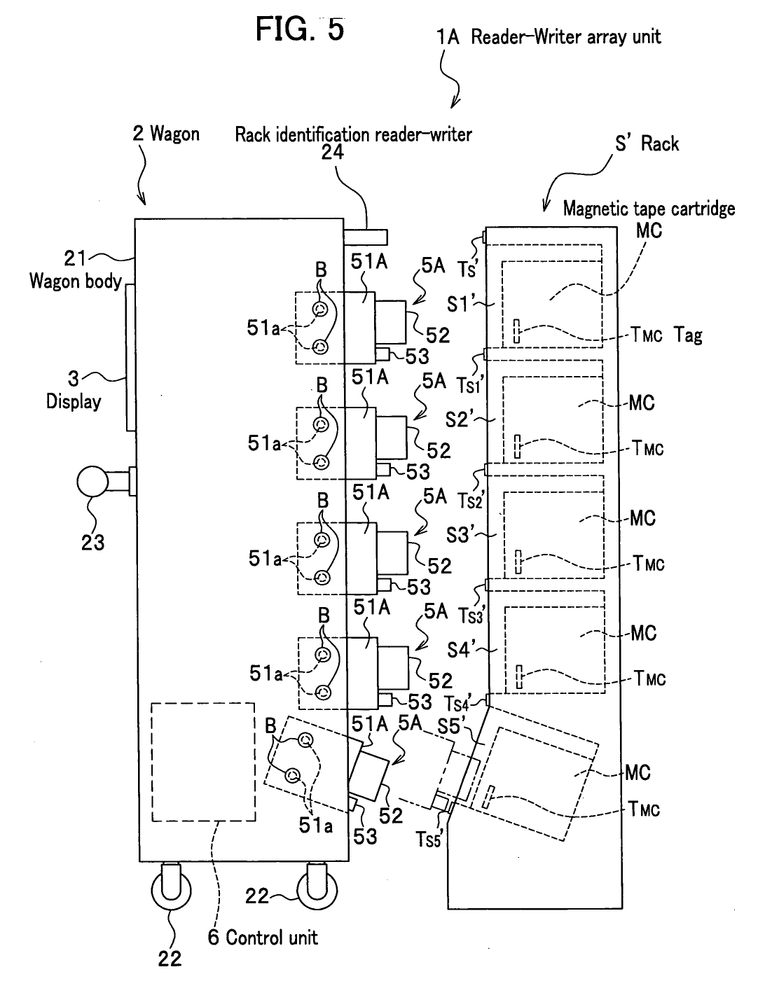

Next, a second embodiment of the present invention will be explained in detail by referring to figures, as needed. FIG. 5 is a side elevational view of a reader-writer array unit faced to a rack according to the second embodiment

Since the second embodiment is one where a part of configuration of the reader-writer array unit according to the first embodiment is changed, many of the parts of the second embodiment are identical to corresponding parts of the first embodiment, then, the corresponding parts are given the same reference symbols, and detailed descriptions of the corresponding parts will not be given.

First, as shown in FIG. 5, in the second embodiment, assume that managed articles are a plurality of magnetic tape cartridges MCs stored in a rack S′. Each magnetic tape cartridge MC has a tag T_{MC} in it.

The rack S′ has five shelves S1′ to S5′. The rack S′ of the second embodiment differs from the rack S of the first embodiment in that the bottom shelf S5′ is inclined so that it is lowered in the depth direction thereof. Because of this, the front sides of the magnetic tape cartridges MCs stored in the bottom shelf S5 face upward in an oblique direction. A tag T_{S′}storing identification information of the rack S′ is attached to the upper central portion of the front side of the rack S′, while facing horizontally. Likewise, tags T_{S1}, to T_{S5}′ storing identification information of each of the shelves S1′ to S5′ are attached to bottom plates of the shelves S1′ to S5′, while facing horizontally.

The reader-writer array unit 1A is equipped with a wagon 2, a display 3 attached to the front of the wagon 2, five reader-writer arrays 5A attached to the back of the wagon 2, and a control unit 6 incorporated in the wagon 2.

The reader-writer array 5A has a support member 51A, a plurality of readers-writers 52 attached to the front central portion of the support member 51A, and a shelf identification reader-writer 53 attached to the front central lower portion of the support member 51A.

The support member 51A is a member with a predetermined depth and has two positioning holes 51a and 51a formed on a lateral side thereof. By matching two through bores in a side plate of a wagon body 21 with the positioning bores 51a and 51a, and by inserting and tightening bolts B, the support member 51A is attached to the wagon body 21.

The five support members 51A are attached to the wagon body 21 so that they correspond to the five shelves S1′ to S5′ of the tack S′. Among them, the bottom support member 51A is attached downward at a predetermined angle to the wagon body 21 so that it corresponds to the bottom shelf S5′ inclined downward in the direction of the depth. This angle can be changed by changing the positions of the through bores of the wagon body 21 into which the bolts B are inserted. Note that the positional relation between the readers-writers 52 and the shelf identification reader-writer 53 on the support member 51A is the same as the reader-writer array 5 of the first embodiment (see FIG. 2).

Operations of the reader-writer array unit 1A of the second embodiment will be described hereinafter.

Initially, the wagon 2 is moved so that the reader-writer arrays 5A face the rack S′. At this time, the front end portions of the readers-writers 52 of the reader-writer arrays 5A are inserted in the shelves S1′ to S5′, and each of the readers-writers 52 faces the tag T_{MC} of a corresponding magnetic tape cartridge MC and reads the management information of the magnetic tape cartridge MC. Note that operations of the rack identification reader-writer 24 and shelf identification reader-writer 53 are the same as the first embodiment. The information thus read is displayed on the display 3, so the operator is able to manage each magnetic tape cartridge MC based on the information.

From the foregoing description, the second embodiment can obtain the following advantages:

(1) The reader-writer array unit 1A has five reader-writer arrays 5A corresponding to the five shelves S1′ to S5′ of the rack S′, so the management information of each of all magnetic tape cartridges MCs stored in the rack S′ can be read at a time. This can shorten the working time and can further improve the working efficiency, compared with the first embodiment.

(2) The reader-writer arrays 5A are attached at predetermined angles to the wagon body 21 by suitably selecting the positions of the through bores formed in the side plate of the wagon body 21. This makes possible the application of the reader-writer array unit 1A to a rack with shelves differing in angle, thereby resulting in improvement of its general-purpose properties.

While the present invention has been described with reference to the second embodiment thereof, the invention is not limited to this embodiment, but can be implemented in various forms.

In the second embodiment, while an attachment angle of the reader-writer array 5A to the wagon body 21 can be varied by changing a position at which the reader-writer array 5A is attached, the present invention is not limited thereto. For example, the reader-writer array 5A may be attached to the wagon body 21 through a turning mechanism. This makes it possible to turn the reader-writer array 5A at an attachment angle of each shelf.

In the second embodiment, while the support members 51A are attached to the wagon body 21, they may be formed as one body. That is, as with the rack identification reader-writer 24, the readers-writers 52 and shelf identification reader-writer 53 may be attached directly to the wagon body 21.

### Third Embodiment

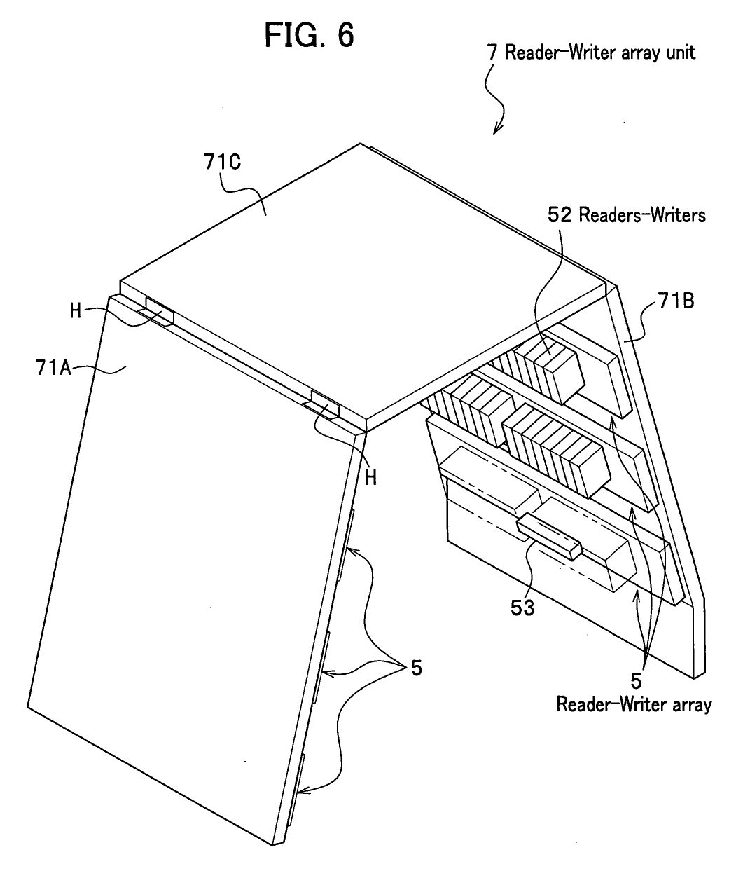

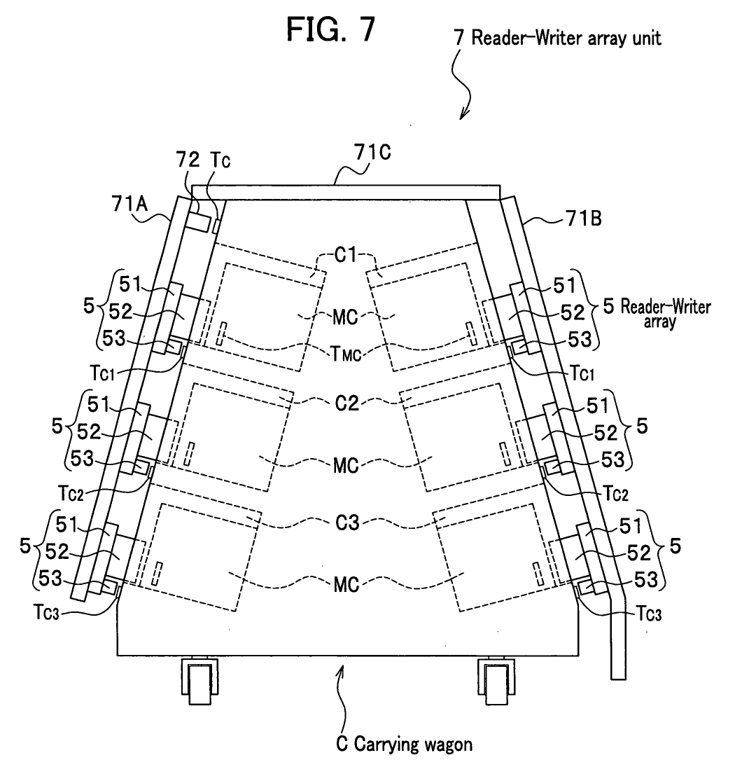

Next, a third embodiment of the present invention will be explained in detail by referring to figures, as needed. FIG. 6 is a perspective view of a reader-writer array unit according to the third embodiment. FIG. 7 is a side elevational view of a reader-writer array unit attached to a carrying wagon according to the third embodiment. In the third embodiment, the same parts as the first embodiment are given the same reference symbols and therefore a detailed description of the same parts will not be given.

In the third embodiment, assume that managed articles are a plurality of magnetic tape cartridges MCs arranged and loaded on a carrying wagon C shown in FIG. 9. Each magnetic tape cartridge MC has a tag T_{MC} in it.

The carrying wagon C has three shelves C1 to C3 at the front and back thereof respectively, and is employed in conveying the magnetic tape cartridges MCs stored in the rack S (see FIG. 8) to other places. A tag T_{C} storing the identification information of the carrying wagon C is attached to the front of the carrying wagon C. Tags T_{C1} to T_{C3} storing the identification information of each of the shelves C1 to C3 are attached to bottom plates CB of the shelves C1 to C3 on the front and back sides of the carrying wagon C. As shown in FIG. 6, the reader-writer array unit 7 is equipped with three base boards 71A, 71B, 71C and a plurality of reader-writer arrays 5 attached to an inside surface of each of the base boards 71A and 71B.

The base boards 71A, 71B, and 71C are rectangular in shape and formed to cover the front side, back side, and top side of the carrying wagon C, respectively. The base boards 71A and 71C are connected through hinges H. Similarly, the base boards 71B and 71C are connected through hinges H. Therefore, the base boards 71A and 71B are free to turn on the hinges H with respect to the top base board 71C.

As shown in FIG. 7, the base board 71A has a wagon identification reader-writer 72 attached to its inside surface. More specifically, the wagon identification reader-writer 72 is attached to face the tag T_{C} for identifying the carrying wagon C, with the base board 71A faced to the front surface of the carrying wagon C. The wagon identification reader-writer 72 identifies each of a plurality of carrying wagons by reading wagon identification information from the tag T_{C} without contacting the tag T_{C}.

The reader-writer arrays 5 are attached in three rows to each of the inside surfaces of the base boards 71A and 71B so that they correspond to the three shelves C1 to C3 of the carrying wagon C. Note that in the third embodiment, shelf identification reader-writers 53 attached to the reader-writer arrays 5 are used to read shelf identification information stored on each of the tags T_{C1} to T_{C3} attached to the carrying wagon C.

Operations of the reader-writer array unit 7 of the third embodiment will be described hereinafter.

Initially, the carrying wagon C is moved into a space formed inside the base boards 71A, 71B, and 71C. At this time, if the base board 71A is turned upward, the carrying wagon C can be easily moved into the space. Then, with the base plate 71C placed on the top surface of the carrying wagon C, the base boards 71A, 71B are faced to the front and back sides of the carrying wagon C.

In this state, the wagon identification reader-writer 72 faces the tag T_{C} and reads the wagon identification information. Each of the readers-writers 52 faces the tag T_{MC} of each magnetic tap cartridge MC and reads the management information of the magnetic tap cartridge MC. Similarly, the shelf identification reader-writers 53 face the tags T_{C1} to T_{C3} and read the shelf identification information of the each shelf. The information read in this manner is transferred to a server (not shown) and managed by it. Therefore, the operator is able to know at the server side that one magnetic tape cartridge MC is being transported with the carrying wagon C.

From the foregoing description, the third embodiment has the following advantages:

(1) Since the reader-writer array unit 7 is constructed separately from the carrying wagon C, it can be used for a plurality of other carrying wagons, and thus has general-purpose properties.

(2) Because the reader-writer arrays 5 can collectively read all magnetic tape cartridges MCs loaded in the carrying wagon C, the work can be completed in a short time.

While the present invention has been described with reference to the third embodiment thereof, the invention is not limited thereto, but can be implemented in various forms.

In the third embodiment, while the base boards 71A and 71B are free to turn on the hinges H with respect to the base board 71C, the present invention is not limited thereto. For instance, the base boards may be of a tunnel type in which the base boards 71B and 71c are fixed at a predetermined angle.

In the third embodiment, while the reader-writer arrays 5 are fixed to the base boards 71A and 71B, the support members 51 of the reader-writer arrays 5 may be formed integrally with the base boards 71A and 71B.

In the third embodiment, although the support member 51 comprises a single member, the present invention is not limited thereto. For example, it may comprise two or more members.

What is claimed is:

1. A reader-writer array for collectively reading or writing management information of a plurality of managed articles which are stored in a rack, comprising:
a plurality of readers-writers for reading or writing the management information which is stored in a RFID tag mounted on each managed article without contact; and
a support member on which the plurality of readers-writers are disposed, and being formed separately from the rack,
wherein the readers-writers are disposed on the support member so that each of the readers-writers corresponds to each position of a plurality of managed articles arranged and stored on at least one shelf of the rack.

2. The reader-writer array according to claim 1,
wherein the support member has a shelf identification reader-writer for reading shelf identification information provided on each shelf of the rack.

3. The reader-writer array according to claim 1,
wherein positioning members for adjusting a positional relation with the rack are disposed on both sides of the support member and are in contact with both sides of the rack.

4. The reader-writer array according to claim 3,
wherein a cross section of the positioning member is formed in a U-shape.

5. The reader-writer array according to claim 2,
wherein positioning members for adjusting a positional relation with the rack are disposed on both sides of the support member and are in contact with both sides of the rack.

6. The reader-writer array according to claim 5, wherein a cross section of the positioning member is formed in a U-shape.

7. A reader-writer array unit, comprising:
a reader-writer array; and
a movable wagon provided with the reader-writer array,
wherein the reader-writer array can collectively read or write management information, without contact, of a plurality of managed articles which are stored in a rack, and comprises a plurality of readers-writers and a support member;
wherein each of the readers-writers reads or writes management information, without contact, which is stored in a RFID tag mounted on each of the managed articles;
wherein the plurality of readers-writers are disposed on the support member and arranged independently from the rack; and
wherein each of the readers-writers is disposed on the support member so that each of the readers-writers corresponds to each position of the plurality of managed articles arranged and stored on at least one shelf of the rack.

8. The reader-writer array unit according to claim 7,
wherein a plurality of reader-writer arrays are disposed in a plurality of rows of the wagon so that the plurality of reader-writer arrays correspond to a plurality of shelves of the rack.

9. The reader-writer array unit according to claim 7,
wherein the reader-writer array is movable in an up-and-down direction with respect to the wagon so that the reader-writer array can correspond to each of a plurality of shelves of the rack.

10. The reader-writer array unit according to claim 7,
wherein the reader-writer array is fixed to the wagon and can be detached therefrom.

11. The reader-writer array unit according to claim 8,
wherein the reader-writer array is fixed to the wagon and can be detached therefrom.

12. The reader-writer array unit according to claim 9,
wherein the reader-writer array is fixed to the wagon and can be detached therefrom.

13. The reader-writer array unit according to claim 7,
wherein the reader-writer array is attached to the wagon so that an angle of the reader-writer array with respect to the wagon can be changed according to a vertical angle of each shelf of the rack.

14. The reader-writer array unit according to claim 8,
wherein the reader-writer array is attached to the wagon so that an angle of the reader-writer array with respect to the wagon can be changed according to a vertical angle of each shelf of the rack.

15. The reader-writer array unit according to claim 9,
wherein the reader-writer array is attached to the wagon so that an angle of the reader-writer array with respect to the wagon can be changed according to a vertical angle of each shelf of the rack.

16. The reader-writer array unit according to claim 10,
wherein the reader-writer array is attached to the wagon so that an angle of the reader-writer array can be changed according to a vertical angle of each shelf of the rack.

17. The reader-writer array unit according to claim 7,
wherein the support member of the reader-writer array is incorporated in the wagon.
